(19) United States
(12) Patent Application Publication
(10) Pub. No.: US 2007/0274313 A1
(43) Pub. Date: Nov. 29, 2007

(54) Method for Routing Data Frames from a Data Content Source to a Destination Device with Buffering of Specific Data and Device Thereof

(76) Inventor: Ming-Tso Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/420,474

(22) Filed: May 25, 2006

(51) Int. Cl. H04L 12/56

(52) U.S. Cl. 370/392; 370/401

(57) ABSTRACT

A method for routing data frames from a data source to a destination device via a communications network is disclosed. The method includes receiving a source data stream including data frames of a plurality of source data channels from the data source; buffering a plurality of data groups corresponding to the source data channels, respectively; when receiving a destination device request for data frames of a specific source data channel, transmitting a specific data group corresponding to the specific source data channel to the destination device and then routing data frames of the specific source data channel received from the data source to the destination device.

### BACKGROUND OF THE INVENTION

1. Field of the Invention

The present invention relates generally to a method and related device for routing data frames, and more specifically, to a method and related device for routing data content frames from a data source to a destination device with buffering of specific data.

2. Description of the Prior Art

As is well known in the art, the time necessary for switching from a first channel to a second channel for Internet video multicast streaming in an Internet television protocol (IPTV) network corresponds to the time needed for an alignment process of an I-frame in an MPEG-based compression streaming file.

The time necessary for switching channels in said IPTV network increases as the number of B-frames and P-frames inserted between I-frames increases. Unfortunately, much effort is placed on inserting more B-frames and P-frames because this action results in an improved compression ratio. As a result, a good compression ratio simply worsens the channel switching delay.

Therefore, it is apparent that new and improved methods and devices are needed to solve the above-mentioned problems.

### SUMMARY OF THE INVENTION

It is therefore one of the objectives of the claimed invention to provide a method for routing data frames from a data source to a destination device via a communications network and the related apparatus thereof to solve the above mentioned problem.

According to an embodiment of the claimed invention, a method for routing data frames from a data source to a destination device via a communications network is disclosed. The method includes receiving a source data stream including data frames of a plurality of source data channels from the data source; buffering a plurality of data groups corresponding to the source data channels, respectively; when receiving a destination device request for data frames of a specific source data channel, transmitting a specific data group corresponding to the specific source data channel to the destination device and then routing data frames of the specific source data channel received from the data source to the destination device.

In addition, a device for routing data frames from a data source to a destination device via a communications network is disclosed. The device includes a receiving/transmitting module and a buffering module. The receiving/transmitting module receives a source data stream including data frames of a plurality of source data channels from the data source. The buffering module, coupled to the receiving module, buffers a plurality of data groups corresponding to the source data channels, respectively.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a diagram of a device for routing data frames from a data source to a destination device according to an embodiment of the present invention.

FIG. 2 is a flow chart showing a method for routing data frames from a data source to a destination device according to an embodiment of the present invention.

FIG. 3 is a timing diagram illustrating routing of data frames from a data source to a destination device over time with buffering according to an embodiment of the present invention.

FIG. 4 is a timing diagram illustrating routing of data frames from a data source to a destination device over time with buffering according to another embodiment of the present invention.

### DETAILED DESCRIPTION

Certain terms are used throughout the following description and claims to refer to particular system components. As one skilled in the art will appreciate, consumer electronic equipment manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

Please note, in the background information presented earlier and the subsequent disclosure, frames of the MPEG stream are referred to as only the I-frames and the P-frames for simplicity. In fact, other frames are possible, such as B-frames. For the purposes of this disclosure, the B-frames and the P-frames can be considered the same while maintaining the spirit of the present invention. Additionally, it is by way of example and not limitation that the MPEG stream is utilized in the first and second embodiments. Other media formats can also be used with the present invention. Media formats that include data frames comprised of a subset of the data that exists in an actual original source frame of the media benefit especially well from the present invention, therefore, MPEG with it P-frames is an exemplarily example.

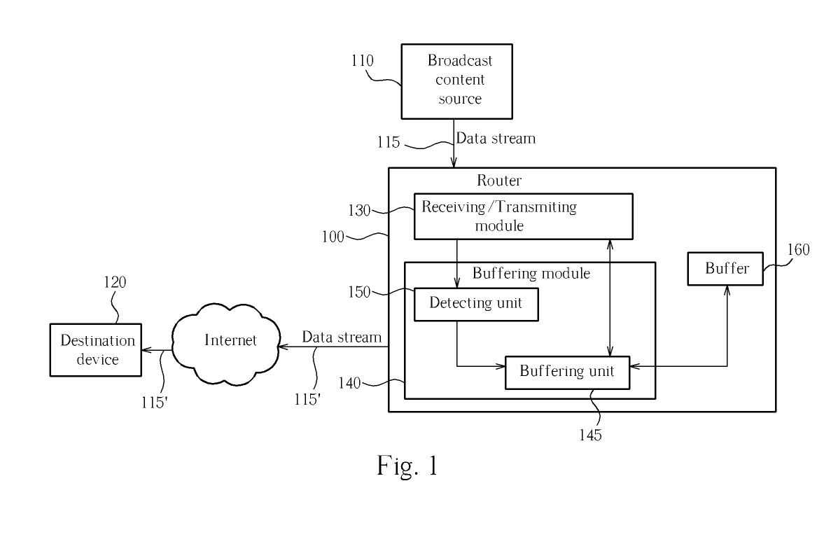

Please refer to FIG. 1. FIG. 1 illustrates a diagram of a router 100 for routing data frames of a data stream 115 from a data source to a destination device according to an embodiment of the present invention. FIG. 1 shows the router 100 for routing data frames in the context of a network where the router 100 receives a data stream 115, for example, an MPEG data stream, from a broadcast content source 110 and transmits/routes the data stream 115′ having been received from the broadcast content source 110 as an output to a destination device 120. In this context, the broadcast content source 110 can be, for example, the source of program channels in the form of IPTV data (i.e., the data stream 115) and the destination device 120 can be, for example, an IPTV client. The communications from the broadcast content source 110 through the router 100 and finally arriving at the destination device 120 is controlled by an Internet multicast protocol, therefore, the router 100 can be, for example, an IGMP router. The link between the router 100 (i.e., the IGMP router) and the broadcast content source 110 can be anything from a simple direct network communications link to the Internet. The present invention does not limit the options for providing said link. Additionally, a second link between the router 100 and the destination device 120 can be anything from a simple direct network communications link to the Internet. Similarly, the present invention does not limit the options for providing said second link.

In FIG. 1, the present invention is shown in an embodiment in the context of the Internet, i.e., the link between the router 100 and the broadcast content source 110 and the link between the router 100 and the destination device 120 is the Internet connection. The broadcast content source 110 can broadcast the data stream 115, the data stream 115 can be an IPTV channel, and the IPTV channel can deliver, for example, an MPEG data stream. There can be any number of IPTV channels (i.e., data streams 115). The present invention is limited only by the capability of, for example, the router 100 (i.e., the IGMP router) that is utilized. In this embodiment, the router 100 comprises a receiving/transmitting module 130, a buffer 160, and a buffering module 140 coupled there between. The receiving/transmitting module 130 is for receiving the data stream 115 (i.e., a source data stream) including data frames of a plurality of source data channels from the broadcast content source 110 and for transmitting data frames of a requested source data channel to the destination device 120. In other words, the receiving/transmitting module 130 plays an important role in routing the data stream 115′ to the destination device 120.

In this embodiment, the buffering module 140 is utilized for buffering a plurality of data groups corresponding to the data stream 115, respectively, into the buffer 160. As shown in FIG. 1, the buffering module 140 includes a buffering unit 145 and a detecting unit 150. The detecting unit 150 is utilized for identifying specific data frames (e.g., the I-frames and P-frames) within the broadcast content source 110 IPTV's MPEG data stream 115. For example, for the plurality of source data channels (i.e., different MPEG data streams 115) of the broadcast content source 110 the detecting unit 150 will detect each I-frame and instruct the buffering unit 145 to copy the identified I-frame to the buffer 160. Additional details explaining the operation of buffering specific frames to the buffer 150 are provided later. Finally, the buffering unit 145, coupled to the detecting unit 150, is utilized for buffering (i.e., temporarily storing) I-frame or I-frames and P-frames in the buffer 160. For example, given the context of FIG. 1, the buffering module 145 will maintain a plurality of buffered data such that each IPTV channel that is received (i.e., data stream 115) will have a corresponding buffered data in the buffer 160. The buffer data is referred to as a data group. Therefore, at any given time the content of the buffer 160 is the data group. Note that the destination device 120 will construct the data stream 115′ of the IPTV network channels by prepending an I-frame or an I-frame and at least one P-frame to the subsequently received frames of the same channel thereby the MPEG decoding process in the destination device 120 can be started immediately after the destination device 120 joins a channel. Because B-frames have less effect on video decoding, B-frames in this embodiment are not buffered for facilitating immediate MPEG decoding. However, this is an example and not a limitation of the present invention. For example, in other embodiments, the buffering module 140 can be designed to buffer the I-frame and all of the subsequent frames before the next I-frame. These alternative designs fall within the scope of the present invention.

Please note that initially, any given IPTV channel will be inactive (i.e., having not been received earlier) and therefore there will not be a corresponding buffered data in the buffer 160 for the given IPTV channel. In this case, the buffered data group including at least an I-frame is created for the requested channel in the buffer 160 and thereafter the present invention is able to route the needed data stream 115′ to the destination device 120 to facilitate immediate MPEG decoding at the destination device 120.

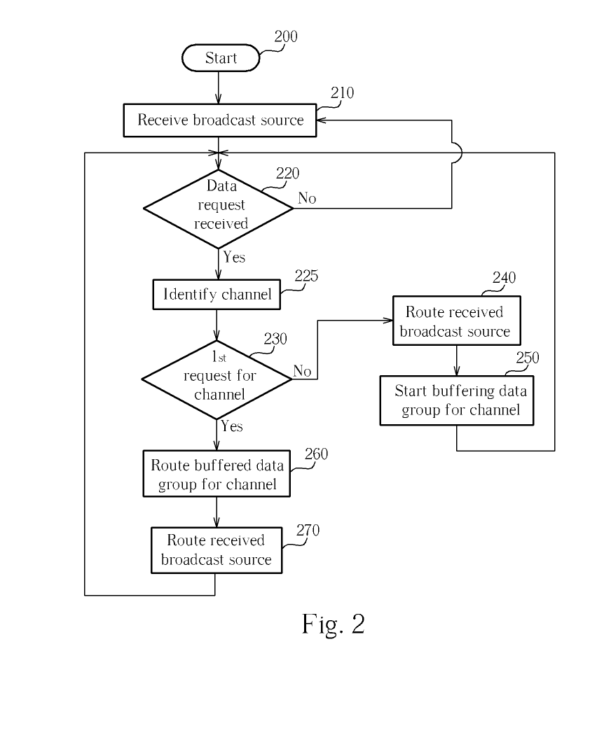

Please refer to FIG. 2. FIG. 2 is a flow chart showing a method for routing data frames from a data source to a destination device according to an embodiment of the present invention. The following is an example illustrating the operation of routing data frames via the router 100 shown in FIG. 1.

Step 200: Start.

Step 210: Receive broadcast source.

Step 220: Is a data request received? If yes, go to step 225; otherwise, go back to step 210.

Step 225: Identify the channel requested by the received data request.

Step 230: Is the received data request a first request for the identified channel? If yes, go to step 240; otherwise, go to step 260.

Step 240: Route the received broadcast source for the identified channel to a destination device 120 that issued the data request.

Step 250: Start buffering the data group for the identified channel, and then go back to step 220.

Step 260: Route the buffer data group for the identified channel to the destination device 120.

Step 270: Route the received broadcast source for the identified channel to the destination device 120 that issues the data request, and then go back to step 220.

In step 200, the flow of the present invention begins. In step 210, the present invention receives a data stream 115 as input from a broadcast source content 110. For example, the broadcast content source 110 is an IPTV server and the data stream 115 is an MPEG-based data stream, however, the data stream 115, as mentioned above, can be any data stream wherein the protocol of the data stream calls for sending less than a complete data description of a current audio or video content. In other words, the data stream 115 being an MPEG stream includes what is called an I-frame that contains a complete data description of a current audio-visual frame and the data stream 115 then includes P-frames that indicate image changes. As is well known to those of average skill in the art, only certain movement changes (i.e. motion vectors) are recorded in certain data stream 115 frames (i.e., P-frames) therefore it is necessary to seek, for example, an I-frame before beginning to present the data stream 115 on the destination device 120. The particulars of the data stream 115 in the context of the MPEG protocol is well known to those of average skill in the art and therefore additional details are omitted for the sake of brevity. Additionally, in step 210, it is assumed that at least one destination device 120 caused the data stream 115 to arrive at the router 100 via a data request, therefore, buffering begins immediately upon receiving the first frame of the data stream 115.

In step 220, a check to determine if a data request has been received. If not, return to step 210 where the present invention simply waits to receive the broadcast source via the data stream 115. If yes, go to step 225 to identify the specific data request. In step 225, the specific requested channel, for example, the IPTV channel, is determined. The channel corresponds to a particular data stream 115. For simplicity, only one data stream and one channel are used through the disclosure. Next, in step 230, the request by the destination device 120 is evaluated to determine if any other destination device 120 has previously requested data from the specific channel that corresponds to the data stream 115. If yes, then the flow goes to step 260 otherwise continues to step 240. In step 240, the received broadcast content source 110 is routed to the requesting destination device 120, and then in step 250, the buffering operation is initiated. In other words, data groups for the identified channel are buffered according to the present invention.

Note that in step 250, the buffering operation, in one embodiment, can include each data group containing a single frame. That is, in the first embodiment the present invention buffers the I-frame only. When the next I-frame is received within the data stream 115, the previously buffered I-frame is replaced in the buffer 160 by the newly received I-frame. In the second embodiment of the present invention, each data group contains a plurality of frames. That is, in second embodiment the I-frame is copied to the buffer 160 and then a plurality of subsequent P-frames following the I-frame are copied to the buffer 160 until the next I-frame is received within the data stream 115. When the next I-frame is received within the data stream 115 then the previously buffered I-frame and subsequently buffered P-frames stored in the buffer 160 are deleted and replaced by the newly received I-frame and subsequently received P-frames. It should be noted the number of the subsequently buffered P-frames could be changed according to different design requirements. The process then repeats. In other words, for each unique broadcast content source 110 that is received by the router 100 a data group is buffered that comprises an I-frame or comprises an I-frame and all following P-frames up to but excluding the next I-frame.

Next, the flow continues from step 250 back to step 220, where subsequent data requests are received and if not the flow further returns to step 210, to await the broadcast content source 110. Alternately, if in step 230 the request for the channel was not the first request, then the flow continues to step 260. In step 260, the buffered data group in the buffer 160 corresponding to the identified channel is sent to the destination device 120 first, in other words, the present invention sends the buffered data group that is stored in the buffer 160 to the destination device 120 for smoothing the MPEG decoding. For example, the buffer 160 contains the last one received I-frame, therefore, the destination device 120 is able to immediately be routed the most recent I-frame of the particular IPTV channel that is requested rather than waiting until the next I-frame is received from the broadcast content source 110 via the data stream 115. This allows the destination device 120 to immediately respond by displaying audio-visual data from the buffered I-frame when a new channel is joined in the IPTV network. In another embodiment, the buffer 160, as mentioned above, contains the data group comprising the last received I-frame and subsequently received P-frames. Please note, that if only the I-frame had been buffered in the buffer 160 then the destination device 120 will display a “jump” effect because one or more frames between the buffered I-frame and the next I-frame in the data stream 115 of the broadcast content source 110 are missing. The fewer missing frames results in a less visible “jump” effect in the audio-visual presentation. Therefore, in the second embodiment of the present invention, the buffering of I-frame and subsequent P-frames reduces the “jump” effect. Please note, in the buffer 160 each IPTV channel has its own buffered I-frame or I-frame and P-frames. Next, subsequently received frames from the broadcast content source 110 are routed directly to the destination device 120 after the buffered data group has been routed to the destination device 120. Next, the flow returns to step 220.

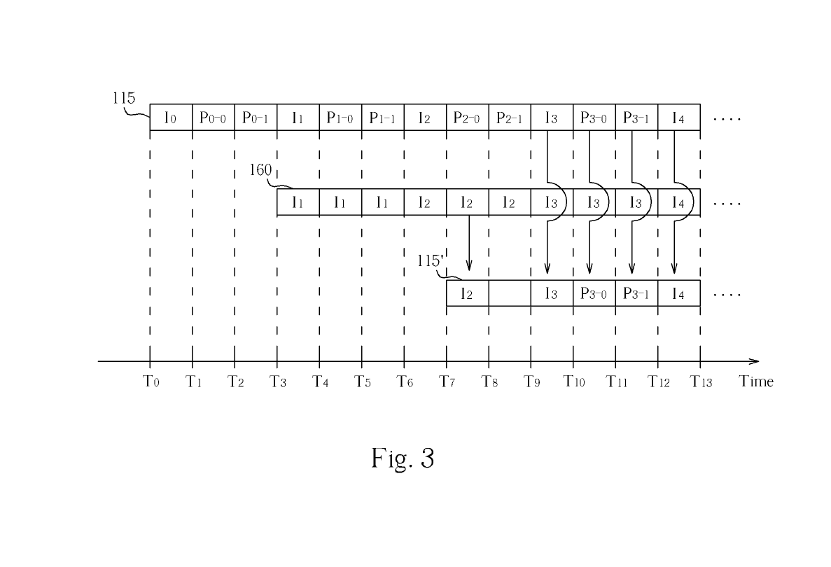

Please refer to FIG. 3. FIG. 3 is a timing diagram illustrating routing of data frames from a data content source 110 to a destination device 120 over time according to an embodiment of the present invention. As an example only, a single data stream 115 is shown originating from the broadcast content source 110 and in this example the data stream 115 is an MPEG stream that would be utilized by an IPTV channel that is compatible with the IPTV protocols and with IGMP routers. In practice, multiple data streams can originate from multiple content sources. In FIG. 3, the first embodiment is illustrated whereby only I-frames are buffered in the buffer 160. The data stream 115 shows that from time T₀-T₁₂ the router 100 begins receiving frames I₀, P₀₋₀, P₀₋₁, I₁, P₁₋₀, P₁₋₁, I₂, P₂₋₀, P₂₋₁, I₃, P₃₋₀, P₃₋₁, and I₄, sequentially. For simplicity, only a few I-frames and P-frames are shown. According to the present invention, the first I-frame I₀ that is received in the data stream 115 by the router 100 at time T₀. As shown in FIG. 3, at time T₁ and T₂ P-frames P₀₋₀ and P₀₋₁ arrive but are not buffered because the first frame of a buffered data group must contain an I-frame. Assume that a data request for a specific channel issued by another destination device is received at time T₂. At time T₃, in addition to forwarding the I-frame I₁ to the destination device that joins the channel, the router 100 copies I-frame I₁ to the buffer 160 because there has been a request for a channel embedded in data stream 115. At time T₄, the buffer 160 remains the same because the data stream 115 has not yet included the next I-frame I₂. Again, the buffer 160 remains the same at time T₅. At time T₆, the next I-frame is received in data stream 115 and is therefore copied whereby the buffer 160 is emptied (i.e., any previously buffered frames are deleted) and the newly received I-frame I₂ is copied to the buffer 160. Additionally, at time T₇ the next I-frame I₃ has not arrived, however, a destination device 120 (i.e., client) has joined the same channel so the data group in the buffer 160 is directly routed to the destination device 120 as shown by data stream 115′ comprising I-frame I₂. At time T₈, the buffer 160 remains the same because the next I-frame I₃ has not arrived in data stream 155. No frame is routed to the destination device 120 and the destination device 120 will experience the “jump” effect as described earlier in the form of a pause (i.e., jerky or non-smooth movement) in the multi-media presentation of the particular channel that the destination device 120 most recently joined. At time T₉, the next I-frame I₃ arrives and is copied to the buffer 160, however, I-frame I₃ is also directly routed to the destination device 120 because the destination device 120 has already received from the router 100 the contents of the buffer 160 (i.e., the destination device 120 has caught up to the most current I-frame I₂ and is ready to accept the next I-frame I₃ as it arrives to the router 100 from the broadcast content source 110). In time T₁₀, P-frame P₃₋₀ arrives, frame P₃₋₀ is not buffered but it is directly routed to the destination device 120 thereby continuing smooth multimedia presentation of the channel for viewing and listening on the destination device 120. The routing continues as shown in FIG. 3 using the method of the present invention as described above.

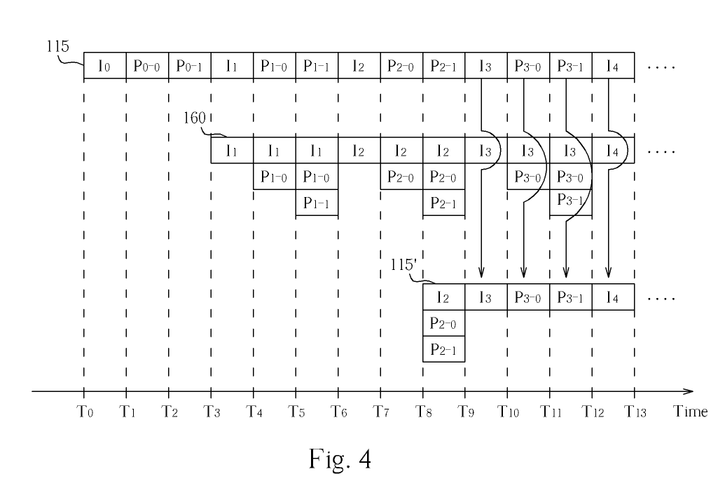

Please refer to FIG. 4. FIG. 4 is a timing diagram illustrating routing of data frames from a broadcast content source 110 to a destination device 120 over time according to another embodiment of the present invention. In this embodiment of the router 100, the I-frames and a plurality of P-frames are both buffered to the buffer 160. The difference between the first embodiment and the second embodiment is visible and audible to the person enjoying the presentation at the destination device 120. This difference is in the form of the previously mentioned “jump” wherein the first embodiment will exhibit a “jump” or skip in the flow of the audio-visual presentation at the destination device 120 and this skip is exactly proportional and directly related to the audio-visual data that is found in the P-frames within the data block 160. In the second embodiment, because the I-frames and P-frames are both buffered and subsequently routed to the destination device 120, all of the frames from the broadcast content source 110 arrive at the destination device 120 and therefore no “jump” or skip in the audio-visual presentation results.

As shown in FIG. 4, at time T₁-T₃, I-frame I₀ and P-frames P₀₋₀, P₀₋₁ arrive but are not buffered because the first frame of a buffered data group must contain an I-frame. Assume that a data request for a specific channel issued by another destination device is received at time T₃. At time T₄, the first I-frame I₁ arrives and is buffered to the buffer 160. In addition, the received I-frame I₁, is routed to the destination device that joins the channel. At time T₅ the first P-frame P₁₋₀ after the I-frame I₁ arrives and is added to the buffer 160 such that the buffer 160 now contains frame I₁ and frame P₁₋₀. At time T₆ the next P-frame P₁₋₁ arrives and is also copied to the buffer 160 as shown in FIG. 4. At time T₇, the next I-frame I₂ arrives, the buffer 160 is emptied, and frame I₂ is copied to the buffer 160. At time T₈ the next P-frame P₂₋₀ arrives and is copied to the buffer 160. At time T₉, the next P-frame P₂₋₁ arrives and is copied to the buffer 160 whereby the buffer 160 now contains frames: I₂, P₂₋₀, and P₂₋₁. Additionally, in time T₉ a destination device 120 joins the same channel and the router 100 immediately routes the contents of buffer 160 to the destination device 120 as shown by data stream 115′ of FIG. 4. In other words, after time T₉, the destination device 120 has caught up to the data stream 115 because the router 100 routed the handful of frames previously received and buffered. This facilitates the immediate display of the corresponding multi-media presentation on the destination device 120 when the destination device 120 joins the active channel. In time T₁₀, the next I-frame I₃ arrives and is buffered as well as directly routed to the destination device 120 as shown in FIG. 4. The routing continues as shown in FIG. 4 using the method of the present invention as described above.

In summary, the router 100 of the present invention allows the destination device 120 to immediately display the content of a broadcast content source 110 (i.e., an IPTV channel) upon requesting (i.e., joining) the broadcast content source 110 without any delay as experienced when utilizing conventional solutions. The present invention facilitates the immediate display of the broadcast content source's 110 multi-media content on the destination device 120 immediately by selectively buffering portions of the broadcast content source 110.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for routing data frames from a data source to a destination device via a communications network, the method comprising:
receiving a source data stream including data frames of a plurality of source data channels from the data source;
buffering a plurality of data groups corresponding to the source data channels, respectively;
when receiving a destination device request for data frames of a specific source data channel, transmitting a specific data group corresponding to the specific source data channel to the destination device and then routing data frames of the specific source data channel received from the data source to the destination device.

2. The method of claim 1, wherein the step of buffering the data groups comprises:
detecting specific data frames within a specific channel of the plurality of source data channels of the source data stream;
buffering a data group by storing a specific data frame of the specific channel of the plurality of source data channels when the first specific data frame is detected;
when a subsequent specific data frame is detected, deleting the data group, and then continuing with buffering a subsequent data group by storing a specific data frame of the specific channel of the plurality of source data channels.

3. The method of claim 2, wherein the source data channels are IGMP channels.

4. The method of claim 2, wherein the source data stream is an MPEG data stream.

5. The method of claim 4, wherein the specific data frames are MPEG I-frames of the specific channel.

6. The method of claim 2, wherein the step of buffering the data group further comprises storing a plurality of frames following the specific data frame until the subsequent specific data frame is detected; and step of continuing buffering the subsequent data group further comprises clearing the buffer.

7. The method of claim 6, wherein the source data channels are IGMP channels.

8. The method of claim 6, wherein the source data stream is an MPEG data stream.

9. The method of claim 8, wherein the specific data frames are MPEG I-frames of the specific channel.

10. The method of claim 9, wherein the plurality of frames following the specific data frame are P-frames only, and the plurality of frames following the subsequent specific data frame are P-frames only.

11. A device for routing data frames from a data source to a destination device via a communications network, the device comprising:
a receiving/transmitting module for receiving a source data stream including data frames of a plurality of source data channels from the data source;
a buffer; and
a buffering module, coupled to the receiving/transmitting module, for buffering a plurality of data groups corresponding to the source data channels, respectively, in the buffer;
wherein when the receiving/transmitting module receives a destination device request for data frames of a specific source data channel, the buffering module transmits a specific data group corresponding to the specific source data channel to the destination device and then routing data frames of the specific source data channel received from the data source to the destination device through the receiving/transmitting module.

12. The device of claim 11, wherein the buffering module comprises:
a detecting unit for detecting specific data frames within a specific channel of the plurality of source data channels of the source data stream; and
a buffering unit, coupled to the detecting unit, for deleting the data group, and then continuing buffering a subsequent data group by storing a specific data frame of the specific channel of the plurality of source data channels when a subsequent specific data frame is detected.

13. The device of claim 12, wherein the source data channels are IGMP channels.

14. The device of claim 11, wherein the source data stream is an MPEG data stream.

15. The device of claim 14, wherein the specific data frames are MPEG I-frames of the specific channel.

16. The device of claim 12, wherein the buffering unit further stores a plurality of frames following the specific data frame until the detecting unit detects the subsequent specific data frame; and clearing the buffer.

17. The device of claim 16, wherein the source data channels are IGMP channels.

18. The device of claim 16, wherein the source data stream is an MPEG data stream.

19. The device of claim 18, wherein the specific data frames are MPEG I-frames of the specific channel.

20. The device of claim 19, wherein the plurality of frames following the specific data frame are P-frames only and the plurality of frames following the subsequent specific data frame are P-frames only.
